(19) United States
(12) Patent Application Publication
(10) Pub. No.: US 2025/0133345 A1
(43) Pub. Date: Apr. 24, 2025

(54) DIAPHRAGM, LOUDSPEAKER, AND DIAPHRAGM MANUFACTURING METHOD

(71) Applicant: Panasonic Automotive Systems Co., Ltd., Kanagawa (JP)

(72) Inventors: Tetsushi ITANO, Osaka (JP); Hirofumi HIGASHI, Osaka (JP); Hiroki SANO, Osaka (JP)

(73) Assignee: Panasonic Automotive Systems Co., Ltd., Kanagawa (JP)

(21) Appl. No.: 18/911,986

(22) Filed: Oct. 10, 2024

(30) Foreign Application Priority Data
Oct. 20, 2023 (JP) 2023-181110

(51) Int. Cl. H04R 7/12; H04R 9/02; H04R 9/04; H04R 9/06; H04R 31/00

(52) U.S. Cl. CPC H04R 7/12; H04R 9/025; H04R 9/045; H04R 9/06; H04R 31/003; H04R 2307/029

(57) ABSTRACT

A diaphragm includes: thermoplastic fiber; and foaming particles.

### CROSS REFERENCE TO RELATED APPLICATION

The present application is based on and claims priority of Japanese Patent Application No. 2023-181110 filed on Oct. 20, 2023.

### FIELD

The present disclosure relates to a diaphragm, a loudspeaker including the diaphragm, and a diaphragm manufacturing method.

### BACKGROUND ART

For example, Patent Literature (PTL) 1 discloses a loudspeaker diaphragm formed by mixing an acrylic composite resin and various fibers to make a sheet, then turning the sheet into a foamed sheet by heating, and then hot press molding the foamed sheet.

### CITATION LIST

### Patent Literature

PTL 1: Japanese Unexamined Patent Application Publication No. 2005-347907

### SUMMARY

However, the above-described diaphragm can be improved upon.

In view of this, the present disclosure provides a diaphragm, and so on, capable of improving upon the above related art.

A diaphragm according to an aspect of the present disclosure includes: thermoplastic fiber; and foaming particles.

A loudspeaker according to another aspect of the present disclosure includes: the above-described diaphragm; a voice coil body connected to the diaphragm; and a magnetic circuit that generates a steady magnetic flux that acts on magnetic flux generated in the voice coil body, the magnetic flux generated in the voice coil body changing based on an electrical signal.

A diaphragm manufacturing method according to another aspect of the present disclosure includes: performing papermaking on a liquid mixture of thermoplastic fiber and foaming particles to form a wet diaphragm; and hot pressing the wet diaphragm.

A diaphragm, and so on, according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a cross-sectional view of a loudspeaker according to an embodiment.

FIG. 2 is an enlarged image schematically illustrating constituent elements of a diaphragm according to an embodiment.

FIG. 3 is a flowchart illustrating the flow of a diaphragm manufacturing method according to an embodiment.

### DESCRIPTION OF EMBODIMENTS

### (Underlying Knowledge Forming Basis of the Present Disclosure)

The inventors have the diaphragm described in the foregoing “Background” section has the following problem. For example, in the manufacturing of the above-described diaphragm, the processes of acrylic composite resin polymerization, foaming heating, and sheet hot pressing require a lot of time, and thus there is the problem of low productivity. In view of this, the present disclosure provides a diaphragm, and so on, capable of improving productivity.

A diaphragm according to an aspect of the present disclosure includes: thermoplastic fiber; and foaming particles.

Accordingly, since the diaphragm includes thermoplastic fiber and foaming particles, the diaphragm can be manufactured by performing, during manufacturing, papermaking on a liquid mixture of the thermoplastic fiber and the foaming particles to form a wet diaphragm, and then hot pressing the wet diaphragm. Therefore, the diaphragm can be manufactured using a method that is simpler than the conventional method, and thus productivity can be enhanced.

Furthermore, since foaming particles are included in the diaphragm, the diaphragm can be made light-weight. In addition, since the foaming particles disposed in the gaps formed by the thermoplastic fiber expand due to heating, the gaps become smaller. Therefore, airtightness and water resistance of the diaphragm can be improved. Furthermore, sound speed can be enhanced, and thus it is possible to improve performance of the loudspeaker.

Furthermore, the diaphragm may further include reinforcing fiber.

Here, since the reinforcing fiber has properties such as lightness and high rigidity, if the diaphragm includes reinforcing fiber, a light and highly-rigid diaphragm can be realized.

Furthermore, the diaphragm may further include fibrillated fiber.

Here, the fibrillated fiber is a fuzzy fiber. This fuzziness makes it possible to more reliably trap the foaming particles. Therefore, it is possible to prevent the foaming particles from falling off from the diaphragm during manufacturing.

Furthermore, the thermoplastic fiber may be at least 10 percent and at most 40 percent of a total weight of the diaphragm, the foaming particles may be at least 5 percent and at most 30 percent of the total weight of the diaphragm, the reinforcing fiber may be at least 20 percent and at most 60 percent of the total weight of the diaphragm, and the fibrillated fiber is at least 10 percent and at most 30 percent of the total weight of the diaphragm.

Accordingly, since the thermoplastic fiber, the foaming particles, the reinforcing fiber, and the fibrillated fiber are combined to satisfy the above-described conditions, a diaphragm having excellent balance between weight and sound quality can be realized.

Furthermore, the diaphragm may further include a water-resistant and oil-resistant agent.

Accordingly, since the diaphragm includes a water-resistant and oil-resistant agent, the resistance of the diaphragm to water and oil can be enhanced.

Furthermore, the diaphragm may further include a loss material.

Accordingly, since the diaphragm includes a loss material, internal loss in the diaphragm can be reduced.

A loudspeaker according to another aspect of the present disclosure includes: the above-described diaphragm; a voice coil body connected to the diaphragm; and a magnetic circuit that generates a steady magnetic flux that acts on magnetic flux generated in the voice coil body, the magnetic flux generated in the voice coil body changing based on an electrical signal.

Accordingly, since the diaphragm included in the loudspeaker includes thermoplastic fiber and foaming particles, the diaphragm can be manufactured by performing, during manufacturing, papermaking on a liquid mixture of the thermoplastic fiber and the foaming particles to form a wet diaphragm, and then hot pressing the wet diaphragm. Therefore, the diaphragm can be manufactured using a method that is simpler than the conventional method, and thus productivity can be enhanced.

Furthermore, since foaming particles are included in the diaphragm, the diaphragm can be made light-weight. In addition, since the foaming particles disposed in the gaps formed by the thermoplastic fiber expand due to heating, the gaps become smaller. Therefore, airtightness and water resistance of the diaphragm can be improved. Furthermore, sound speed can be enhanced, and thus it is possible to improve performance of the loudspeaker.

A diaphragm manufacturing method according to another aspect of the present disclosure includes: performing papermaking on a liquid mixture of thermoplastic fiber and foaming particles to form a wet diaphragm; and hot pressing the wet diaphragm.

Accordingly, the diaphragm can be manufactured by performing papermaking on a liquid mixture of the thermoplastic fiber and the foaming particles to form a wet diaphragm, and then hot pressing the wet diaphragm. Therefore, the diaphragm can be manufactured using a method that is simpler than the conventional method, and thus productivity can be enhanced.

Furthermore, since foaming particles are included in the diaphragm, the diaphragm can be made light-weight. In addition, since the foaming particles disposed in the gaps formed by the thermoplastic fiber expand due to heating, the gaps become smaller. Therefore, airtightness and water resistance of the diaphragm can be improved. Furthermore, sound speed can be enhanced, and thus it is possible to improve performance of the loudspeaker.

### Embodiment

Hereinafter, embodiments will be specifically described with reference to the Drawings. It should be noted that each of the embodiments described hereafter illustrates a specific example of the present disclosure. The numerical values, shapes, materials, constituent elements, the arrangement and connection of the constituent elements, steps, the processing order of the steps, etc., shown in the following exemplary embodiments are mere examples, and are therefore not intended to limit the present disclosure. Furthermore, among the constituent elements in the following embodiments, constituent elements not recited in any one of the independent claims defining the most generic concepts are described as arbitrary constituent elements.

### Loudspeaker

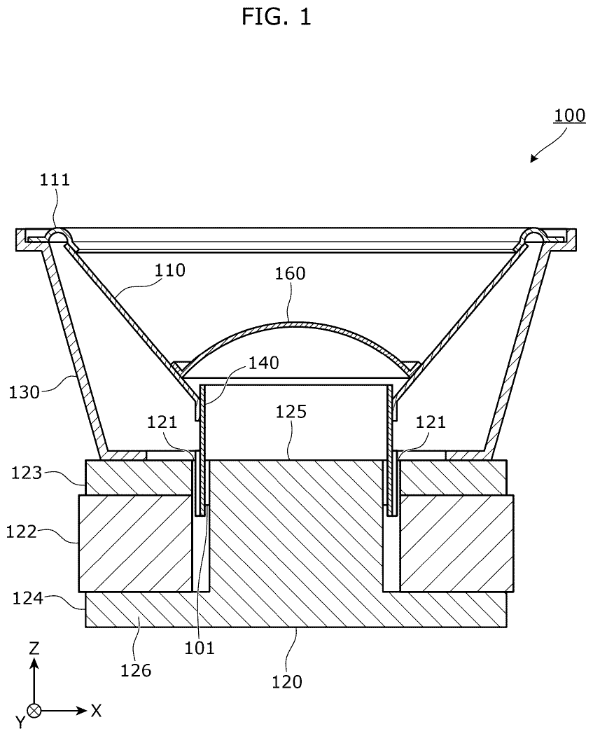

First, a loudspeaker including a diaphragm according to the present disclosure will be described. FIG. 1 is a cross-sectional view of loudspeaker 100 according to an embodiment.

As illustrated in FIG. 1, loudspeaker 100 includes diaphragm 110, magnetic circuit 120, base component 130, and voice coil body 140. Diaphragm 110 is a component to which voice coil body is connected, and which, by being displaced in the front-back direction (Z-axis direction in the figures) with reference to a neutral position, based on the vibration of voice coil body 140, causes air to vibrate to thereby emit sound. In present embodiment, the shape of diaphragm 110 is of the so-called cone type which has a diameter that gradually decreases from the front side (Z-axis positive side in the figures) to the back side. The peripheral portion of diaphragm 110 is connected to the rim portion of base component 130 via edge 111 that has greater flexibility and restorability than diaphragm 110. It should be noted that the shape, etc., of diaphragm 110 is not particularly limited, and may be exemplified as a circular cone shape, an ellipsoidal cone shape, a pyramid shape, or may be a flat shape such as a disk, an elliptic plate, a flat plate, and so on.

Magnetic circuit 120 is a component that generates a steady magnetic flux that acts on magnetic flux that is generated in voice coil body 140 and changes based on an electrical signal. Magnetic circuit 120 is fixed to base component 130 so as to be located behind diaphragm 110, and includes ring-shaped magnetic gap 121 located at a position opposite to diaphragm 110. Magnetic gap 121 is a gap that generates a steady magnetic flux in a direction that crosses the magnetic flux generated by voice coil body 140.

Magnetic circuit 120 is of the outer magnet type and includes cylindrical magnet 122 magnetized in the front-back direction, annular top plate 123 disposed on the diaphragm 110-side face of magnet 122, disk-shaped base plate 124 disposed across magnet 122 from top plate 123, and center pole 125 that is inserted through a through hole in top plate 123 from base plate 124 and, together with top plate 123, forms magnetic gap 121. Furthermore, base plate 124 and center pole 125 are formed integrally. Top plate 123, base plate 124, and center pole 125 are made of magnetic material.

It should be noted that the type of magnetic circuit 120 is not particularly limited, and an inner magnet type magnetic circuit 120 may be adopted.

Magnet 122 is a permanent magnet that is in the shape of a circular plate, in the center of which is formed a through hole through which center pole 125 is inserted. In magnet 122, one end portion in the thickness direction (the front-back direction) is an N pole and the other end portion is an S pole. Top plate 123 is fixed to the face on one of the polar sides of magnet 122, and base plate 124 is fixed on the face on the other polar side.

Base component 130 is a component referred to as a so-called frame, or the like, that serves as a structural base of loudspeaker 100, and holds magnetic circuit 120 and diaphragm 110 in predetermined positions. Base component 130 is made of, for example, metal, resin, or the like.

Voice coil body 140 is a component having a back end portion disposed inside of magnetic gap 121 of magnetic circuit 120 and a front end portion connected to diaphragm 110. Voice coil body 140 is a component that generates magnetic flux based on an inputted electrical signal and vibrates in the front-back direction as a result of interaction with magnetic circuit 120. The winding axis (central axis) of voice coil body 140 is disposed in the vibration (oscillation) direction (Z-axis direction in the figures) of diaphragm 110, and is orthogonal to the direction of the magnetic flux within magnetic gap 121. In present embodiment, voice coil body 140 includes a coil that is configured by a wire material made of metal such as copper being wound multiple times into loops (i.e., into a cylindrical shape), and a bobbin around the periphery of which the coil is wound. The bobbin is a tubular component made of a material such as aluminum or resin. The back end portion of the bobbin is placed inside magnetic gap 121 after the front end portion of the bobbin is connected to diaphragm 110.

### Diaphragm

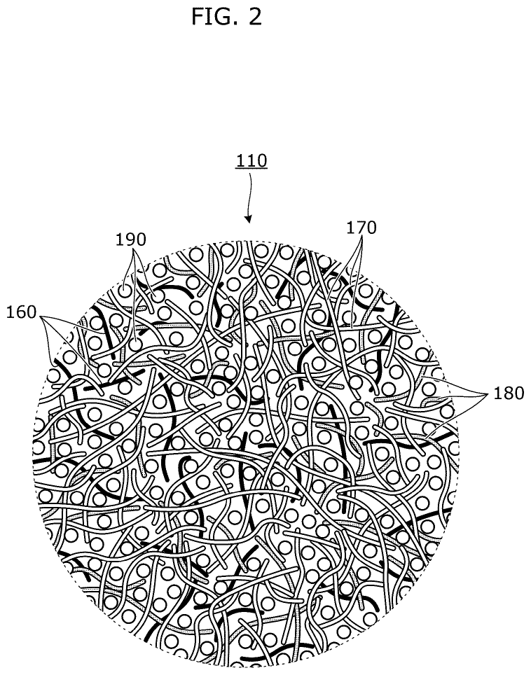

Next, specific constituent elements of diaphragm 110 will be described. FIG. 2 is an enlarged image schematically illustrating constituent elements of diaphragm 110 according to the embodiment. FIG. 2 is a magnified view of the surface of diaphragm 110. As illustrated in FIG. 2, diaphragm 110 includes thermoplastic fiber 160, reinforcing fiber 170, fibrillated fiber 180, and foaming particles 190.

Thermoplastic fiber 160 is a fibrous body made of resin, for example. Thermoplastic fiber 160 functions as a binder between reinforcing fiber 170. For example, polypropylene (PP) resin, polyethylene terephthalate (PET) resin, and so on, can be given as resins from which thermoplastic fiber 160 is made. The thermoplastic fiber 160 content of diaphragm 110 may be in a range of from 10% to 40% of the total weight of diaphragm 110.

Reinforcing fiber 170 is a fibrous body having a higher modulus of elasticity that thermoplastic fiber 160. Inorganic material fibers such as glass fiber, alumina fiber, carbon fiber, fibers derived from plants such as bamboo and hemp, and so on, can be used for reinforcing fiber 170. The reinforcing fiber 170 content of diaphragm 110 may be in a range of from 20% to 60% of the total weight of diaphragm 110.

Fibrillated fiber 180 is a fuzzy fiber that is split in the axis direction. For example, thermoplastic synthetic fiber fibrillated pulp, KPUL (registered trademark), SWP (registered trademark), and so on, can be used for fibrillated fiber 180. The fibrillated fiber 180 content of diaphragm 110 may be in a range of from 10% to 30% of the total weight of diaphragm 110.

Foaming particles 190 are acrylic fine particles that expand when heated. By being heated, foaming particles 190 expand by about several ten-fold. For example, foaming microspheres can be used for foaming particles 190. The foaming particle 190 content of diaphragm 110 may be in a range of from 5% to 30% of the total weight of diaphragm 110.

It should be noted that, in the present embodiment, the percentage content is such that thermoplastic fiber 160 is 20% of the total weight of diaphragm 110, reinforcing fiber 170 is 40% of the total weight of diaphragm 110, fibrillated fiber 180 is 20% of the total weight of diaphragm 110, and foaming particles 190 is 20% of the total weight of diaphragm 110. Furthermore, it is preferable that the specific gravity of diaphragm 110 is at most 0.5. This enables weight reduction of magnetic circuit 120 and loudspeaker 100. In addition, it is preferable that the thickness of diaphragm 110 is at most 0.5 mm. This also enables weight reduction of magnetic circuit 120 and loudspeaker 100 is possible.

### Diaphragm Manufacturing Method

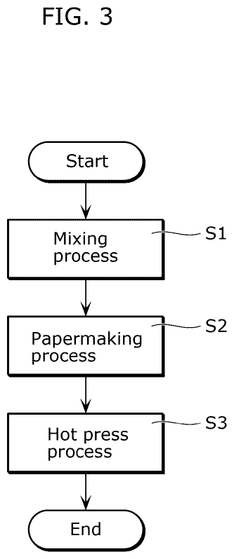

Next, the method for manufacturing diaphragm 110 will be described. FIG. 3 is a flowchart illustrating the flow of a method for manufacturing diaphragm 110.

As illustrated in FIG. 3, in mixing process S1, thermoplastic fiber 160, reinforcing fiber 170, fibrillated fiber 180, and foaming particles 190 are mixed into water at a predetermined ratio to produce a liquid mixture. At this time, thermoplastic fiber 160, reinforcing fiber 170, fibrillated fiber 180, and foaming particles 190 are mixed uniformly by agitating the liquid mixture using a mixer.

Next, in papermaking process S2, the liquid mixture is filled into a papermaking mold corresponding to the shape of diaphragm 110 to drain the water. Accordingly, a wet diaphragm 110 is formed. At this time, foaming particles 190 are trapped by the fuzziness of fibrillated fiber 180, and thus preventing foaming particles 190 from falling out together with the water.

Next, in hot press process S3, the wet diaphragm 110 is heated and pressed using a hot press machine. Accordingly, diaphragm 110 dries up and hardens. At this time, foaming particles 190 inside diaphragm 110 expand. At this time, foaming particles 190 disposed in the gaps formed by the entwined fibers (that is, thermoplastic fiber 160, reinforcing fiber 170, and fibrillated fiber 180) reduce the gaps by expanding. Accordingly, in diaphragm 110, airtightness and water resistance are improved.

### Advantageous Effects, Etc.

Accordingly, since diaphragm 110 includes thermoplastic fiber 160 and foaming particles 190, diaphragm 110 can be manufactured by performing, during manufacturing, papermaking on a liquid mixture of the thermoplastic fiber and the foaming particles to form a wet diaphragm, and then hot pressing the wet diaphragm. Therefore, diaphragm 110 can be manufactured using a method that is simpler than the conventional method, and thus productivity can be enhanced.

Furthermore, since foaming particles 190 are included in diaphragm 110, diaphragm 110 can be made light-weight. In addition, since foaming particles 190 disposed in the gaps formed by thermoplastic fiber 160 expand due to heating, the gaps become smaller. Therefore, since the airtightness and water-resistance of diaphragm 110 are improved, sound speed can be improved, and thus it is possible to improve performance of loudspeaker 100. The sound speed of the diaphragm is preferably at least 2500 m/s. Accordingly, the frequency band can be widened, and a rich sound having a large amount of information can be outputted.

Furthermore, since foaming particles 190 are included in diaphragm 110, diaphragm 110 can be made light-weight. In addition, since foaming particles 190 disposed in the gaps formed by thermoplastic fiber 160 expand due to heating, the gaps become smaller. Therefore, airtightness and water resistance of diaphragm 110 can be improved. Furthermore, sound speed can be enhanced, and thus it is possible to improve performance of loudspeaker 100.

Here, since reinforcing fiber 170 has properties such as lightness and high rigidity, if diaphragm 110 includes reinforcing fiber 170, diaphragm 110 that is light and highly-rigid can be realized.

Here, fibrillated fiber 180 is a fuzzy fiber. This fuzziness makes it possible to more reliably trap foaming particles 190. Therefore, it is possible to prevent foaming particles 190 from falling off from diaphragm 110 during manufacturing.

Thermoplastic fiber 160 is at least 10 percent and at most 40 percent of the total weight of diaphragm 110, foaming particles 190 are at least 5 percent and at most 30 percent of the total weight of diaphragm 110, reinforcing fiber 170 is at least 20 percent and at most 60 percent of the total weight of diaphragm 110, and fibrillated fiber 180 is at least 10 percent and at most 30 percent of the total weight of diaphragm 110. Since thermoplastic fiber 160, foaming particles 190, reinforcing fiber 170, and fibrillated fiber 180 are combined to satisfy the above-described conditions, diaphragm 110 having excellent balance between weight and sound quality can be realized.

### OTHER EMBODIMENTS

Although diaphragm 110 according to the present disclosure has been described thus far based on the foregoing embodiment, the present disclosure is not limited to the foregoing embodiment. Various modifications to the present embodiment that can be conceived by a skilled person or forms obtained by combining constituent elements in different embodiments, for as long as they do not depart from the essence of the present disclosure, may be included in the scope of one or more aspects of the present disclosure.

Diaphragm 110 may further include a water-resistant and oil-resistant agent. When diaphragm 110 includes a water-resistant and oil-resistant agent, the resistance of diaphragm 110 to water and oil can be enhanced. Resistance to chemicals such as car shampoos, and so on, is also enhanced. A fluorine-based water-resistant and oil-resistant agent can be used as the water-resistant and oil-resistant agent.

Diaphragm 110 may further include a loss material. When diaphragm 110 includes a loss material, internal loss in diaphragm 110 can be reduced. The loss material is also referred to as a diaphragm loss material or braking material, and is a material having a function of reducing internal loss.

In the foregoing embodiment, diaphragm 110 is exemplified as including thermoplastic fiber 160, reinforcing fiber 170, fibrillated fiber 180, and foaming particles 190. However, it is sufficient that diaphragm 110 includes at least thermoplastic fiber 160 and foaming particles 190.

### SUPPLEMENTARY NOTES

The foregoing embodiments, and so on, disclose the subsequent techniques.

### (Technique 1)

A diaphragm including:

thermoplastic fiber; and

foaming particles.

### (Technique 2)

The diaphragm according to technique 1, further including:

reinforcing fiber.

### (Technique 3)

The diaphragm according to technique 2, further including:

fibrillated fiber.

### (Technique 4)

The diaphragm according to technique 3, in which

the thermoplastic fiber is at least 10 percent and at most 40 percent of a total weight of the diaphragm,

the foaming particles are at least 5 percent and at most 30 percent of the total weight of the diaphragm,

the reinforcing fiber is at least 20 percent and at most 60 percent of the total weight of the diaphragm, and

the fibrillated fiber is at least 10 percent and at most 30 percent of the total weight of the diaphragm.

### (Technique 5)

The diaphragm according to any one of techniques 1 to 4, further including:

a water-resistant and oil-resistant agent.

### (Technique 6)

The diaphragm according to any one of techniques 1 to 5, further comprising:

a loss material.

### (Technique 7)

A loudspeaker including:

the diaphragm according to any one of techniques 1 to 6;

a voice coil body connected to the diaphragm; and

a magnetic circuit that generates a steady magnetic flux that acts on magnetic flux generated in the voice coil body, the magnetic flux generated in the voice coil body changing based on an electrical signal.

### (Technique 8)

A diaphragm manufacturing method including:

performing papermaking on a liquid mixture of thermoplastic fiber and foaming particles to form a wet diaphragm; and

hot pressing the wet diaphragm.

### FURTHER INFORMATION ABOUT TECHNICAL BACKGROUND TO THIS APPLICATION

The disclosure of the following patent application including specification, drawings, and claims is incorporated herein by reference in its entirety: Japanese Patent Application No. 2023-181110 filed on Oct. 20, 2023.

### INDUSTRIAL APPLICABILITY

The present disclosure is applicable to a diaphragm, and so on, that is formed by papermaking.

1. A diaphragm comprising:
thermoplastic fiber; and
foaming particles.

2. The diaphragm according to claim 1, further comprising:
reinforcing fiber.

3. The diaphragm according to claim 2, further comprising:
fibrillated fiber.

4. The diaphragm according to claim 3, wherein
the thermoplastic fiber is at least 10 percent and at most 40 percent of a total weight of the diaphragm,
the foaming particles are at least 5 percent and at most 30 percent of the total weight of the diaphragm,
the reinforcing fiber is at least 20 percent and at most 60 percent of the total weight of the diaphragm, and
the fibrillated fiber is at least 10 percent and at most 30 percent of the total weight of the diaphragm.

5. The diaphragm according to claim 4, further comprising:
a water-resistant and oil-resistant agent.

6. The diaphragm according to claim 4, further comprising:
a loss material.

7. A loudspeaker comprising:
the diaphragm according to claim 1;
a voice coil body connected to the diaphragm; and
a magnetic circuit that generates a steady magnetic flux that acts on magnetic flux generated in the voice coil body, the magnetic flux generated in the voice coil body changing based on an electrical signal.

8. A diaphragm manufacturing method comprising:
performing papermaking on a liquid mixture of thermoplastic fiber and foaming particles to form a wet diaphragm; and
hot pressing the wet diaphragm.
